(19) United States
(12) Patent Application Publication
(10) Pub. No.: US 2023/0053179 A1
(43) Pub. Date: Feb. 16, 2023

(54) ACOUSTIC PROTECTION SYSTEM FOR A MOTOR VEHICLE

(71) Applicant: Treves Products, Services & Innovation, Paris (FR)

(72) Inventors: Arnaud Duval, Paris (FR); Guillaume Crignon, Paris (FR)

(21) Appl. No.: 17/795,429

(22) PCT Filed: Jan. 26, 2021
(86) PCT No.: PCT/EP2021/051770

§ 371 Date: Jul. 26, 2022

(30) Foreign Application Priority Data
Jan. 28, 2020 (FR) FR2000839

(51) Int. Cl. B60R 13/08; G10K 11/168; B32B 3/04; B32B 3/26; B32B 5/18; B32B 5/02; B32B 15/04; B32B 15/14; B32B 15/08

(52) U.S. Cl. CPC B60R 13/083; G10K 11/168; B32B 3/04; B32B 3/266; B32B 5/18; B32B 5/02; B32B 15/046; B32B 15/14; B32B 15/08; B32B 2307/102; B32B 2605/00; B32B 2307/51; B32B 2307/732; B32B 2307/54

(57) ABSTRACT

The invention relates to an An acoustic protection system for a motor vehicle has two walls extending opposite each other; an elastically compressible acoustic decoupling layer arranged in compression at least along its periphery between the walls, the layer having two opposing faces pressed respectively against each of the walls, the faces being connected to each other by an edge, the layer being enclosed in a bag made from plastic film closed so as to form a sealed barrier on the edge, at least one air passage hole being provided in the bag opposite at least one of the faces, the hole being arranged at a distance from the edge so as to provide, around the hole, a seal created by the bag bearing on the corresponding wall.

### FIELD OF THE DISCLOSURE

The invention relates to an acoustic protection system for a motor vehicle.

### BACKGROUND

It is known to produce an acoustic protection system for a motor vehicle, said system comprising:
two walls extending opposite each other,
an elastically compressible acoustic decoupling layer arranged in compression at least along its periphery between said walls, said layer having two opposing faces pressed respectively against each of said walls, said faces being connected to each other by an edge.

The presence of such a compressed decoupling layer makes it possible to obtain a damping effect resulting in an improvement of the treatment of the “solidborne” noise.

In addition, the fact of using a decoupling layer instead of discrete elements—such as compressible studs—not only makes it possible to produce a damping but also to improve the acoustic transparency of the whole (acoustic insulation).

Such an arrangement may particularly be implemented outside of the passenger compartment.

It then makes it possible to prevent a portion of the outside noise from being propagated inside the passenger compartment, which makes it possible to reduce the weight of the acoustic protection means usually implemented within said passenger compartment, regardless of whether they are based on insulation and/or absorption principles.

It also makes it possible to avoid, or at least reduce, the use of damping materials, for example based on bitumen (treatment sometimes known as IFF), which are usually deposited on the walls of the floor panel type.

The result of all of these options is a simplification and a weight reduction of the vehicle.

However, in some cases it is necessary, for example when the decoupling layer is close to the ground, to guarantee the non-penetration of liquids—particularly water—within said layer, and this particularly through its edge that is not protected by the walls, this in order to preserve the decoupling properties of said layer.

In addition, such a protection must be achieved while making it possible for the decoupling layer to be able to compress during its mounting within the system.

### SUMMARY OF THE DISCLOSURE

The aim of the invention is to propose a system making it possible to meet these requirements.

To this end, the invention proposes an acoustic protection system for a motor vehicle, said system comprising:
two walls extending opposite each other,
an elastically compressible acoustic decoupling layer arranged in compression at least along its periphery between said walls, said layer having two opposing faces pressed respectively against each of said walls, said faces being connected to each other by an edge,

knowing that:
said layer is enclosed in a bag made from plastic film closed so as to form a sealed barrier on said edge,
at least one air passage hole is provided in said bag opposite at least one of said faces, said hole being arranged at a distance from said edge so as to provide around said hole a seal created by said bag bearing on said corresponding wall.

With the arrangement proposed, the decoupling layer is protected from liquids by the bag.

Furthermore, the presence of at least one hole in the bag makes it possible to evacuate a portion of the air present in the bag during the compression of the decoupling layer during its mounting within the system.

In addition, the positioning of the hole such as provided makes it possible to create a sealing around its periphery, and thus to prevent liquids from penetrating from the outside towards said hole.

### BRIEF DESCRIPTION OF THE DRAWINGS

Further specific features and advantages of the invention will appear in the following description, made with reference to the appended figures, wherein:

FIG. 1 is a schematic representation in exploded perspective view of a system according to one embodiment,

FIG. 2 is a schematic representation in sectional view of the system of FIG. 1 in non-exploded view.

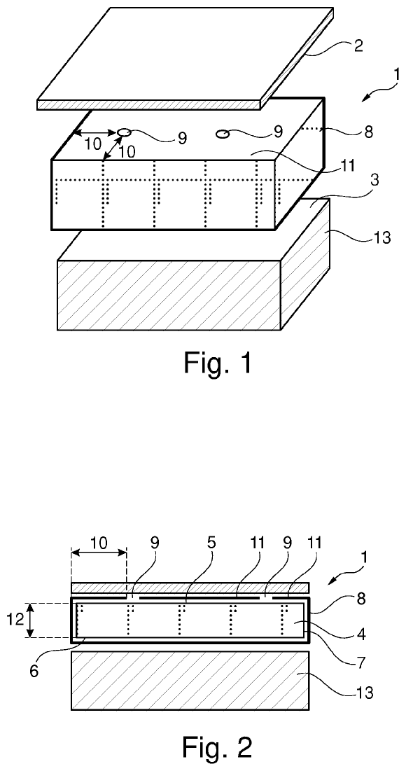

### DETAILED DESCRIPTION OF THE PREFERRED EMBODIMENTS

With reference to the figures, an acoustic protection system 1 for a motor vehicle is described, said system comprising:
two walls 2, 3 extending opposite each other,
an elastically compressible acoustic decoupling layer 4 arranged in compression at least along its periphery between said walls, said layer having two opposing faces 5, 6 pressed respectively against each of said walls, said faces being connected to each other by an edge 7,

knowing that:
said layer is enclosed in a bag 8 made from plastic film closed so as to form a sealed barrier on said edge,
at least one—plurality according to the embodiment shown—air passage hole 9 is provided in said bag opposite at least one 5, 6 of said faces—only one 5 according to the embodiment shown—, said hole being arranged at a distance 10 from said edge so as to provide around said hole a seal 11—particularly with regard to liquids coming from the outside such as water—created by said bag bearing on said corresponding wall—in this case the wall 2 according to the embodiment shown.

According to the embodiment shown, the decoupling layer 4 is compressed according to its entire surface, which makes it possible to optimise the damping effect. According to one embodiment, the hole 9 is arranged at a distance 10 of at least 20 mm from the edge 7.

According to miscellaneous embodiments, the decoupling layer 4 is based on foam—either cut, or moulded, particularly in the case of a complex geometry—or fibrous material.

According to one embodiment, the density of the decoupling layer 4 is between 25 and 80 kg/m3.

According to one embodiment, the decoupling layer 4 is compressed by 5 to 50% in relation to its thickness in the non-compressed state, and in particular by 25 to 35%.

According to one embodiment, the compressed decoupling layer 4 has a thickness 12 between 5 and 50 mm.

According to one embodiment, the decoupling layer 4 has a relative compression stress-strain characteristic less than 5 kPa, and particularly less than 3 kPa, the measurement being made for an indentation of 25% of the initial thickness of the test specimen during the fourth compressive cycle, said characteristic being measured according to ISO 3386-1 standard in force on the priority date of the present application.

According to one embodiment, the decoupling layer 4 has a Young's modulus less than 50 kPa, particularly less than 20 kPa.

According to one embodiment, the decoupling layer 4 has a structural loss factor greater than 0.18, so as to have accentuated damping characteristics, at a temperature of 20° C. and at a frequency of 20 Hz.

According to the embodiment shown, the walls 2, 3 are substantially parallel.

According to the embodiment shown, one wall 3 is formed by a battery pack face 13—in particular for an electric vehicle—and the other wall 2 is formed by a floor panel of said vehicle.

According to one embodiment not shown, the walls 2, 3 are part of a hollow metal body, said body particularly being a wing inner panel.

What is claimed is:

1. An acoustic protection system for a motor vehicle, said system comprising:
two walls extending opposite each other,
an elastically compressible acoustic decoupling layer arranged in compression at least along its periphery between said walls, said layer having two opposing faces pressed respectively against each of said walls, said faces being connected to each other by an edge,
said layer being enclosed in a bag made from plastic film closed so as to form a sealed barrier on said edge,
at least one air passage hole provided in said bag opposite at least one of said faces, said hole being arranged at a distance from said edge so as to provide around said hole a seal created by said bag bearing on said corresponding wall.

2. The system according to claim 1, the hole being a distance of at least 20 mm from the edge.

3. The system according to claim 1, the decoupling layer comprising one of foam or fibrous material.

4. The system according to claim 1, the decoupling layer being compressed by 5 to 50% in relation to its thickness in the non-compressed state.

5. The system according to claim 1, the compressed decoupling layer having a thickness between 5 and 50 mm.

6. The system according to claim 1, the decoupling layer has having a Young's modulus less than 50 kPa.

7. The system according to claim 1, the decoupling layer having a structural loss factor greater than 0.18, at a temperature of 20° C. and at a frequency of 20 Hz.

8. The system according to claim 1, one wall formed by a battery pack face and the other wall formed by a floor panel of the vehicle.

9. The system according to claim 1, the walls being part of a hollow metal body.
